(19) United States
(12) Patent Application Publication
(10) Pub. No.: US 2010/0332308 A1
(43) Pub. Date: Dec. 30, 2010

(54) METHOD AND SYSTEM FOR DYNAMICALLY CUSTOMIZING A TRANSACTION OF SUBSIDIZED GOODS USING AN IDENTITY MEDIUM

(76) Inventors: Ke Lip Yap, Selangor (MY); Wu Wei Ngau, Kuala Lumpur (MY); Yi Hao Leong, Selangor (MY)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/919,521

(22) PCT Filed: Feb. 27, 2008
(86) PCT No.: PCT/MY08/00016

§ 371 Date: Aug. 26, 2010

(51) Int. Cl. G06Q 20/00; G06Q 30/00; G06Q 40/00

(52) U.S. Cl. 705/14.34; 705/17; 705/44

(57) ABSTRACT

A subsidy and payment system dynamically determines a consumer's subsidy entitlement status and calculates a customized subsidy applicable to purchase of subsidized goods based on the consumer's authenticated government-endorsed identity. The subsidy and payment system additionally facilitates electronic payments from the consumer and subsidy rebates to the consumer in connection with the purchase of subsidized goods based on the authenticated government-endorsed identity without requiring additionally information or actions from the consumer.

### TECHNICAL FIELD

This invention relates generally to a system for transactions of subsidized goods. More particularly, this invention relates to methods and systems for dynamically customizing a subsidy to a consumer for a transaction based on authentication of the consumer to a government-endorsed identity.

### BACKGROUND

Most countries have some forms of subsidy schemes directed at targeted individuals and/or groups (hereinafter collectively referred to as consumers). Typically, subsidy schemes are implemented or developed by government and/or other suitable agencies (hereinafter collectively referred to as a subsidy agency). The subsidy schemes may be implemented in various ways. As an example, a subsidy agency may implement a national policy that distributes subsidies to targeted consumers. The targeted consumers may be identified, for example, based on subsidy authorizing documentations. As another example, the authorizing agency may directly issue stored-value cards to targeted consumers, whom may then use the stored-value cards to purchase subsidized goods.

Subsidy schemes are usually expensive to implement and are often prone to abuse. For example, under a national policy scheme, the subsidy agency may require targeted consumers, at their inconvenience, time and expense, to visit designated locations to receive approval for subsidies. Once approved, the subsidy agency may issue documentations and/or pre-paid subsidy cards to the consumers for proving subsidy eligibility, for example, at the time of purchase. The consumers may be required to repeat this process, for example, to qualify for other subsidies. If at any time a change is made to the subsidy policy, the authorizing process, the issued documentation, etc., the consumers may be required to undergo a new process to maintain subsidy qualification. The inefficiencies and inconveniences associated with current authorizing processes of subsidy schemes significantly increase the cost associated with these schemes.

In addition, most existing subsidy schemes are also prone to abuse. Specifically, once a consumer is approved for subsidy, existing schemes often provide none or very little monitoring capability to ensure proper usage of the subsidy by the authorized consumer. For example, a consumer, in possession of a pre-paid subsidy card or subsidy authorizing documentation, may abuse the subsidy privileges by allowing a third party to use these articles to receive subsidized goods. As another example, a qualified consumer may purchase more than consumable quantities of subsidized goods and resell the surplus portions for profit. Many other inefficiencies exist in current subsidy schemes, some of which will be described in more detail in connection with a specific fuel subsidy example.

Specifically, many oil-producing countries provide substantial fuel subsidies directed at targeted consumers such as low-income individuals and fuel-driven domestic industries. The general goal of a fuel subsidy scheme may be to improve national quality of life, for example, through the subsidization of low income family spending on fuel necessary for daily life (e.g., fuel for commuting). The goal may also be to ensure the survival and to strengthen the competitiveness of fuel-driven domestic industries.

A typical current scheme has a number of problems. On the individual consumer level, the current fuel subsidy scheme indiscriminately provides subsidized fuels to all consumers at fuel retailing locations throughout the country. The current scheme is incapable of determining whether a consumer qualifies for a fuel subsidy. Through this type of scheme, the government indiscriminately allows all consumers to purchase fuel at significantly subsidized prices. The difference between the market price and the subsidized price, which is generally pre-set, is then either entirely assumed by the subsidy agency or allocated in a forced sharing scheme between the subsidy agency and the relevant fuel retailer/distribution companies (hereinafter collectively referred to as retailer). When the market price rises to a high level, this type of scheme creates large uncontrolled exposures to the subsidy agency and may cause major losses to the fuel retailers in a forced sharing scheme. More details of such a scheme will be discussed below in connection with FIG. 1.

FIG. 1 shows an illustrative operational flowchart of a typical fuel subsidy system as currently implemented. At stage 102, any consumer may purchase fuel at a subsidized price at a fuel retailer. The subsidized price may be predetermined by the relevant subsidy agency. In some cases, the fuel retailer, at stage 104, may periodically receive a company subsidy entitlement list sent from the subsidy agency at stage 106. This list, affecting only special groups, may set out, for example, industries, large companies, and/or groups that may qualify for special group-type large quantity subsidies at special prices. For example, this list may specify subsidized fuel quotas for diesel fuels allocated to large commercial consumers such as trucking companies. These commercial consumers may then purchase subsidized fuel in accordance with the quota from the fuel retailer. The purchase transactions and the quotas may be managed and monitored, for example, in connection with the commercial consumer's corporate fuel account or any other suitable account that manages its allotted subsidy fuel usage. In some instances, a commercial consumer may pay for the subsidized fuel using credit, for example, from its corporate fuel account or any other suitable account, if, for example, the corporate consumer passes a credit risk assessment of the fuel retailer. In one example, the fuel retailer may require that the commercial consumer make a deposit prior to fuel transactions. The commercial consumer may settle the credit transactions, for example, periodically with the fuel retailer. Alternatively, the fuel retailer may require that the commercial consumer settle subsidized fuel transactions using cash payments.

The subsidy entitlement list generally does not regulate the purchase of subsidized fuel by the individual consumers and/or unspecified commercial consumers. For the general sale of subsidized fuel to these consumers, the fuel retailer would make the sales at the subsidized price and generate subsidy claims to submit to the relevant subsidy agency at stage 108. In some instances, the subsidy claim may be for the entire difference between the market price and the subsidized price at transaction time. In such cases, the relevant subsidy agency bears the burden of the entire subsidy amount. In other instance, the subsidy claim may be allowed for only a pre-determined subsidy amount per volume (e.g., a specific amount per liter) that is specified by the subsidy agency. In such cases, the fuel retailer may have to supplement some of the subsidy amount per volume when the market price significantly exceeds the pre-set subsidized price and the pre-determined subsidy amount per volume is not sufficient to cover the entire difference between the two. In response to a subsidy submission, the subsidy agency may allocate an appropriate fuel subsidy rebate to the fuel retailer at stage 110. The fuel subsidy process illustrated in FIG. 1 demonstrates a pull-type process flow in which the subsidy agency plays a very passive role. More specifically, the subsidy agency has little control over how much subsidy rebate it may be required to make to the fuel retailers at any one time. The amount of rebate is instead largely dependent upon at least one of the volume of sale and the market price. The fuel retailers, in the instances where the subsidy agency provides only a fixed difference between the market price and the pre-set subsidized price per volume, are also exposed to possible supplemental subsidy requirements, which are dependent upon fluctuating market prices and sales volume that are out of their control. This may, in some cases, significantly reduces or put the fuel retailers out of profitability.

Needless to say, the above-illustrated sale of subsidized fuel is highly inefficient at achieving the subsidy scheme's intended goals and may actually encourage a variety of social ills. For example, the un-restricted scheme permits sales to foreign and/or other non-qualified consumers, which may lead to substantial cross-border fuel smuggling to countries with less or no subsidy in similar goods. The inefficiencies of the above scheme also results in high cost to the subsidy agency, which may inflate dramatically as global fuel prices continue to climb.

Improvements toward a more targeted subsidy scheme largely hinge on improvements in identification of eligible consumers. Typically, the most accurate identification for an individual in a particular country exists in the form of a government-endorsed identity medium, such as, for example, a passport, a social security card, a national identification card, or any other suitable identification medium (hereinafter collectively referred to as identity medium) that is reflective of a government-endorsed identity. Some countries issue identity mediums that include built-in chip-based or other suitable technologies that are capable of providing an electronic means for storing applications (e.g., security programs), values (e.g., cash), individual information (e.g., driver's license), and/or any other suitable applications and/or information. Currently, most identity mediums are used exclusively for identification purposes, while many other applications and services associated with an individual may be authenticated based on the identity mediums, for example, through a third party authentication process such as a credit card approval process authenticated based on a passport. In other words, an identity medium itself is typically not directly utilized to facilitate any applications and/or services authenticated based on it. The intermediary authentication process by a third party creates yet another layer of inefficiency and reduces the overall trustworthiness of the authentication.

One area that frequently employs third party authentication is that of electronic payments using, for example, third party mediums such as credit cards, debit cards, bank cards, etc. Financial institutions may issue their proprietary payment mediums such as the above-mentioned payment cards to a consumer based on an authentication of the consumer's government-endorsed identity. Most typically, the financial institution examines, for example, one or more government-endorsed identity mediums associated with the consumer including a passport, a government issued identity card, or any other suitable government-endorsed identity document. The relevant financial institution may then utilize its own backend process to authenticate the individual, for example, through a credit check or other process against the government-endorsed identity medium. If this authentication process is successful, the financial institution may assign the consumer a secondary identity unique to that institution (i.e., an identity associated with a credit card account, a bank account, etc.). This secondary identity may then be used by the consumer, along with, for example, a unique pin, a user-id, etc. for future verification with the assigning financial institution. As a result, an individual having a number of electronic payment mediums associated with one or more financial institutions may acquire a plurality of secondary identities, which may require separate authentication by each institution, even though the same government-endorsed identity of the consumer is the basis for all these secondary identities.

FIG. 2 shows an illustrative diagram for performing an electronic payment transaction using an electronic payment medium mentioned above at a fuel retailer 202. A consumer may initiate the electronic payment transaction by inserting or sliding the electronic payment medium through a reader. The consumer may be required to concurrently provide additional authentication information such as a pin associated with the electronic payment medium. The fuel retailer 202 may be affiliated with an acquiring bank 204 to which the reader forwards the authentication information obtained from the consumer and the consumer's electronic payment medium. The acquiring bank 204 may then process and forward suitable information relevant to the electronic payment transaction to a central interchange 206. Upon receiving the information, the central interchange 206 may match the transaction with an appropriate issuer bank 208. Issuer bank 208 may be the bank that issued the electronic payment medium. If the transaction is approved by the issuer bank 208, for example, when the information provided by the consumer and/or associated with the electronic payment medium properly authenticates against a secondary identity and against a pre-allocated credit amount, the acquiring bank 204 may notify the retailer 202 to accept the electronic payment. In some instances, the retailer 202 may be required to perform an authentication to ensure that the consumer is the proper owner of the electronic payment medium, for example, when the electronic payment medium is a credit card. The retailer 202 may authenticate, for example, through manual inspection of signatures, through photo comparison, or through any other suitable arrangement. This authentication may take place either prior or subsequent to the retailer 202 initiating the electronic payment transaction. After completion of the electronic payment transaction, the acquiring bank 204 may bill the issuer bank 208 on behalf of the retailer 202 for the transaction amount. The issuer bank 208, may, in due time, collect payment from the consumer. Generally, the retailer 202 pays commissions to the acquiring bank 204, issuer bank 208, and/or credit card providers for facilitating the electronic payment transaction.

There are many inherent inefficiencies and risks associated with separate electronic payment medium issuance, disparate user authentication, and non-uniform infrastructure maintenance in the above arrangement. For example, because much of the electronic payment transaction infrastructure is provided by unrelated financial institutions, it is difficult and costly to promulgate new technology that would be compatible across the network. Each of the financial institutions may also incur unnecessary cost in performing redundant maintenance activities. This redundancy is most apparent in authentication, where financial institutions may maintain a plurality of secondary identities for a consumer having a single government-endorsed identity. This redundancy not only increases the cost to each financial institution, it also significantly reduces transparency and security of electronic payment transactions among the institutions.

In view of the above, it is desirable to provide a subsidy and payment system in which a consumer may be authenticated against a single government-endorsed identity independent of any secondary identity or third party authentication. It is also desirable that the subsidy and payment system dynamically determines the consumer's subsidy entitlement status and calculates a customized subsidy applicable to purchase of subsidized goods by the consumer based on the authenticated government-endorsed identity. It is additionally desirable that the subsidy and payment system automatically facilitates electronic payments from the consumer and subsidy rebates to the consumer in connection with the purchase of subsidized goods based on the authenticated government-endorsed identity, without requiring additional information or actions from the consumer.

### SUMMARY

Consistent with the principles of the present invention, a subsidy and payment system provides secure authentication of a consumer against a single government-endorsed identity. The system dynamically determines the consumer's subsidy entitlement status and calculates a customized subsidy applicable to purchase of subsidized goods based on the authenticated government-endorsed identity. The subsidy and payment system additionally facilitates electronic payments from the consumer and subsidy rebates to the consumer in connection with the purchase of subsidized goods based on the authenticated government-endorsed identity without requiring additional information or actions from the consumer.

In some embodiments, a consumer may initiate purchase of subsidized goods, for example, by submitting an identity medium such as a national identity card to an electronic reader associated with the subsidy and payment system. The reader may capture information associated with the identity medium including, for example, information stored in the magnetic strip of the identity medium, information stored in a smart chip on the identity medium, or information otherwise obtainable from the identity medium. The subsidy and payment system may additionally capture other information from the consumer, including, for example, biometric information such as a fingerprint.

In some embodiments, the subsidy and payment system may dynamically determine a customized subsidy applicable towards the purchase of the subsidized goods. In one suitable arrangement, the subsidy and payment system may automatically determine subsidy entitlement status of the consumer for the purchase based on an authentication of the consumer to a government-endorsed identity. For example, the authentication of the consumer to the government-endorsed identity may be based on a comparison of a portion of the information captured from the submitted identity medium and the consumer against trusted information associated with the government-endorsed identity. In one particular arrangement, the system may compare captured biometric information such as fingerprint information against similar information that is, for example, extracted from a trusted data source such as a government database.

In some embodiments, the subsidy and payment system may automatically calculate a customized subsidy applicable to the purchase based on one or more characteristics associated with the authenticated government-endorsed identity. The one or more characteristics may include, for example, characteristics associated with the consumer that are relevant to the purchase of the subsidized goods. For example, the consumer's driver license class, vehicle capacity, and income level may constitute the one or more characteristics considered in connection with purchase of subsidized fuel. In some embodiments, the one or more characteristics may be extracted from one or more secure data sources such as government databases. The automatic calculation of customized subsidy may additionally involve application of one or more policy schema processes and preferences schema processes by the subsidy and payment system towards the one or more characteristics. The subsidy and payment system may evaluate, score, and weigh the characteristics in connection with the above processes to determine the consumer's subsidy entitlement status. The subsidy and payment system may additionally utilize a subsidy guide or map to determine a specific customized subsidy value, range, or level applicable to the purchase of subsidized goods.

In some embodiments, the subsidy and payment system may dynamically perform payment settlement for the purchase. The payment settlement may include automatically initiating a payment transaction from a qualified payment account associated with the consumer. The subsidy and payment system may identify the qualified payment account and initiate the payment transaction from the qualified payment account based on the authenticated government-endorsed identity without requiring additional actions from the consumer. The subsidy and payment system may communicate with, for example, the relevant financial institution associated with the qualified payment account to facilitate the payment transaction. In some embodiments, the automatically initiated payment transaction from the consumer may be in the form of a cash transaction.

In some embodiments, the subsidy and payment system may automatically obtain a subsidy rebate for the customized subsidy applied to the purchase, for example, from the relevant subsidy agency. In one suitable arrangement, the subsidy and payment system may automatically submit a subsidy rebate request for the customized subsidy to the subsidy agency either in real-time or for periodical consolidated rebate from the subsidy agency.

Further features and embodiments of the present invention will become apparent from the description and the accompanying drawings. It will be understood that the features mentioned above and those described hereinafter may be used not only in the combination specified but also in other combinations or on their own, without departing from the scope of the present invention. It will also be understood that the foregoing background, summary, and the following description of the systems consistent with the principles of the present invention are in no way limiting on the scope of the present invention and are merely illustrations of a preferred embodiment of the present invention.

### BRIEF DESCRIPTION OF THE DRAWINGS

Referring now to the drawings, in which like numerals represent like elements throughout the several Figures, aspects of the present invention and the exemplary operating environment will be described.

FIG. 1 is an illustrative flowchart of a current fuel subsidy scheme.

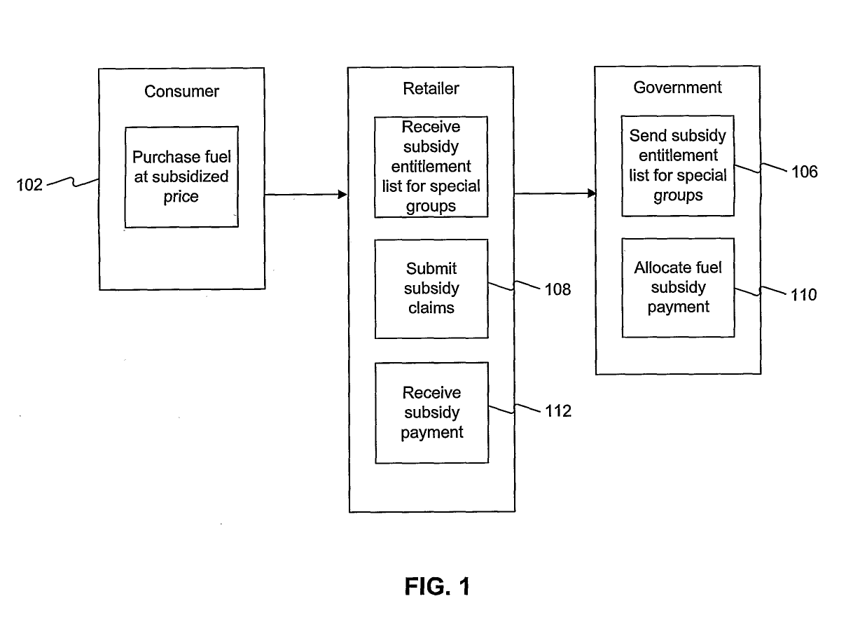

FIG. 2 is an illustrative diagram of a current electronic payment transaction.

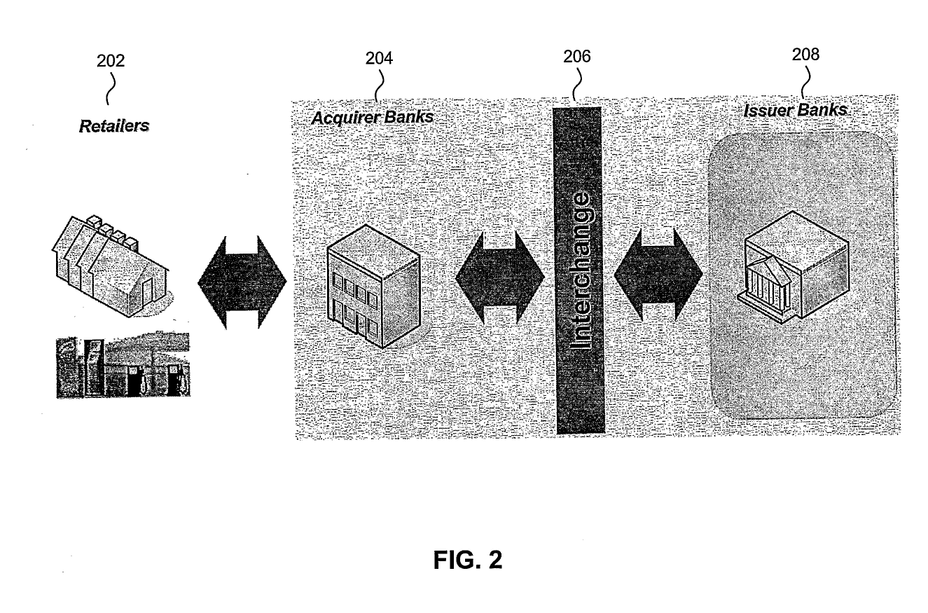

FIG. 3 is an illustrative flowchart of exemplary processes involved in utilizing an authenticated identity medium to facilitate an automated transaction for subsidized goods.

FIG. 4 is an illustrative diagram of data mining system and process involved in dynamic determination of subsidy entitlement of a consumer.

FIG. 5 is an exemplary table listing subsidy qualification criteria.

FIG. 6 is an exemplary subsidized fuel transaction in accordance with a disclosed embodiment.

FIG. 7 is another exemplary subsidized fuel transaction in accordance with one embodiment of the present invention.

FIG. 8 is an illustrative flowchart of exemplary processes involved in dynamic authentication and registration of a consumer.

FIG. 9 is an illustrative computer system capable of implementing some elements of a disclosed embodiment.

FIG. 10 is another illustrative computer system capable of implementing some elements of a disclosed embodiment.

FIG. 11 is one exemplary network computer system capable of implementing some elements of a disclosed embodiment.

### DETAILED DESCRIPTION

The following detailed description refers to the accompanying drawings. Wherever possible, the same reference numbers are used in the drawings and the following description to refer to the same or similar parts. While several exemplary versions and features of the invention are described herein, modifications, adaptations and other implementations are possible, without departing from the spirit and scope of the invention. For example, substitutions, additions or modifications may be made to the components illustrated in the drawings, and the exemplary methods described herein may be modified by substituting, reordering or adding stages to the disclosed methods. Accordingly, the following detailed description does not limit the invention. Instead, the proper scope of the invention is defined by the appended claims.

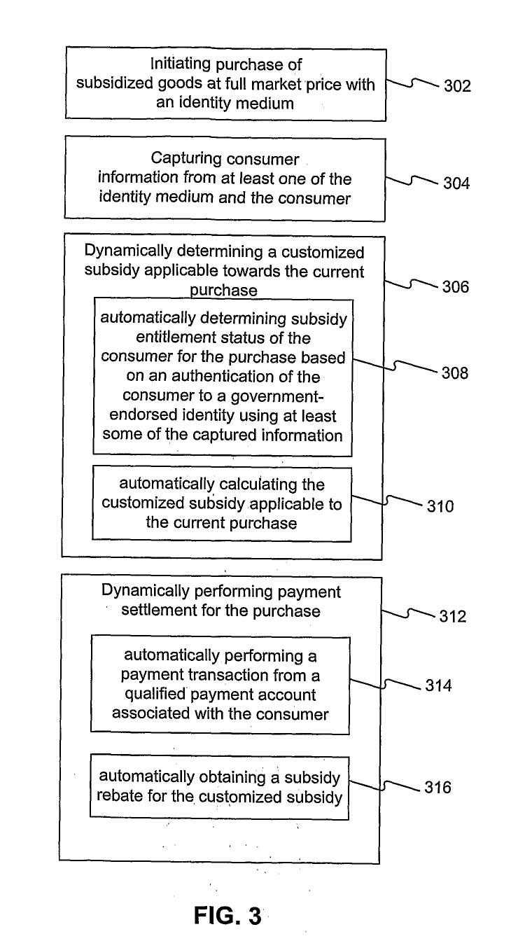

FIG. 3 is an illustrative flowchart of exemplary processes involved in utilizing an authenticated identity medium to facilitate an automated transaction for subsidized goods. In this particular example, fuel is described as the subsidized goods. However, one skilled in the art would understand that any other suitable types of subsidized goods, including, for example, flour, sugar, oil, and any other suitable subsidized goods, may act as replacement without departing from the spirit and scope of the present invention.

At 302, a consumer may initiate purchase of fuel with an identity medium. For example, the consumer may insert, slide, or otherwise submit a national identity card to a reader coupled to an automated fueling system. In response, the reader may capture relevant information associated with the identity medium and the consumer, including, for example, information sufficient to facilitate direct authentication of the consumer against a government-endorsed identity, information sufficient to facilitate customization of subsidy, and/or any other suitable information, at 304.

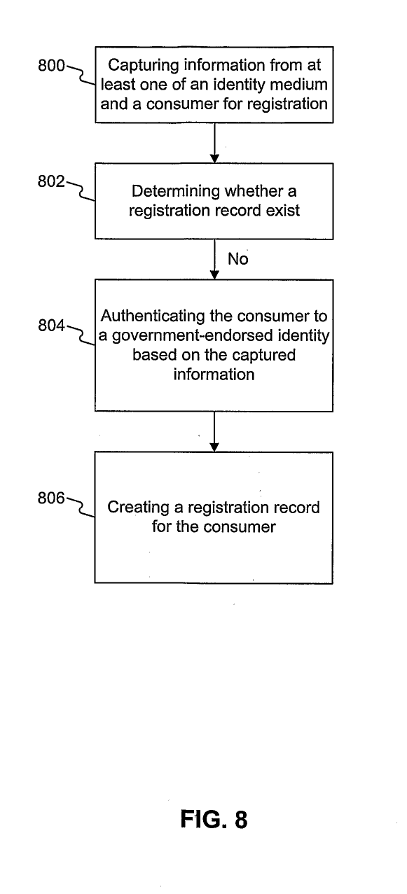

In one suitable approach, the capturing of information at 304 may include collection of biometric information such as, for example, fingerprint, eye scan, facial structure scan, and/or any other suitable biometric information. Hardware suitable for collection of biometric information may be provided, for example, instead of or in conjunction with an identity medium reader, to facilitate capturing of biometric information. Other captured information may include, for example, identity information, payment information, prior registration information, and/or any other suitable information. The captured information may be extracted in connection with the identity medium (e.g., from a smart chip mounted on the identity medium, from the magnetic strip of the identity medium, etc.). Captured prior registration information may include information that the consumer has previously provided, for example, during an identity medium registration process. One example of such a registration process will be discussed in more detail in connection with FIG. 8 below.

At 306, a customized subsidy entitlement applicable towards the consumer-initiated purchase of 302 may be dynamically determined. The determination and calculation of subsidy entitlement at 306 may involve a number of sub-processes. In one suitable arrangement, the consumer may be automatically authenticated, for example, against a government-endorsed identity at 308. One suitable approach for this authentication may include implementation of a data mining process that, for example, utilizes at least some of the information captured from the identity medium at 304 and other captured information such as biometric information to dynamically extract data from one or more trusted external data sources such as databases containing government-authenticated information associated with the consumer.

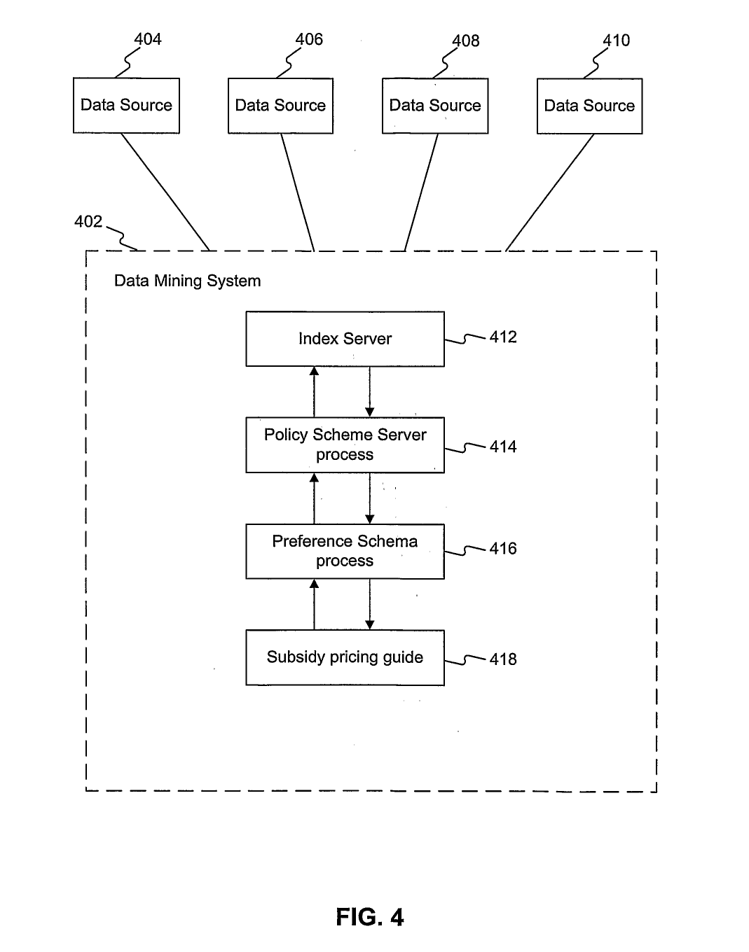

FIG. 4 shows an illustrative diagram of such a data mining system and process that contributes to the dynamic authentication of a consumer and the dynamic determination of subsidy entitlement status for that consumer. In this example, the data mining system 402 may extract relevant information from a plurality of trusted data sources (i.e., government agency databases). These data sources may contain, for example, government-authenticated information and/or other trusted information for making an accurate consumer authentication against a government-endorsed identity and/or for assessing subsidy entitlement. Some suitable data sources may include, for example, database 404, which may contain government-authenticated identity information such as name, address, age, biometric characteristics, and any other suitable identity-related information. Specifically, database 404 may be, for example, one or more social security information databases, national identity databases, immigration databases, and/or any other suitable identity information databases. Database 406 may contain vehicle-related information such as model, make, year, engine capacity, insurance, and/or any other suitable vehicle-related information. Database 406 may be, for example, one or more DMV databases, national vehicle registry databases, and/or any other suitable registry of vehicle information. Database 408 may contain consumer income and/or tax type information including, for example, annual income, tax, deductions, and/or any other information of similar type. Database 408 may be, for example, one or more IRS databases, related social security databases, and/or any other suitable databases. Database 410 may represent any other useful data sources of relevant information for consumer authentication and/or subsidy calculation. Database 410 may be, for example, one or more databases containing census information, statistical information such as vehicle safety statistics, and/or any other suitable information. It will be understood by those skilled in the art that while the above databases 404-410 are provided as specific examples, a variety of databases may be utilized in the data mining process for many types of information without departing from the spirit and scope of the present invention.

In one embodiment, data mining system 402 may directly search and extract data from the above-described data sources, for example, through secure connections. Alternatively, intermediate pooling systems and processes may be implemented that provide, for example, only information deemed to be necessary and/or appropriate for consumer authentication and/or subsidy determination. It is also possible that some or all of the databases are made available to data mining only on a partially transparent basis such that only some information are searchable by the data mining process. In such situations and in situations where a plurality of databases, each housing large amounts of information in remote storage locations, it may be desirable to provide one or more index server 412 to maintain an indexing service to the various desirable and accessible information. As an example, an indexing server may provide a plurality of pointers, each pointing, for example, to a storage location for a certain type of relevant information in one of the databases 404-410. When extracting information, the data mining system 402 may, for example, look up one or more pointers associated with the desired information type in the index server 412 and may follow the pointer to extract the desired information from the indicated location in databases 404-410. In some embodiments, the index server 412 may dynamically update the various pointers to reflect, for example, changes in storage format and/or location in the relevant databases. In some embodiments, the index server 412 may additionally store some extracted information, for example, to enable quick access to that information at a later time.

In conjunction with the extraction of relevant information from databases 404-410, the consumer may be authenticated based on some of the extracted information to establish an authenticated and government-endorsed identity. The authentication may be carried out, for example, against information captured at 304 of FIG. 3. In one example, the captured information from 304 of FIG. 3 may include identity information extracted from the identity medium, including, for example, name, national identification number, address, age, etc. In some embodiments, captured information from 304 of FIG. 3 may also include biometric information such as fingerprint, eye scan, facial structure scan, etc. The biometric information may be obtained, for example, from biometric readers and in some instances may be directly compared to comparable biometric information stored, for example, within a smart chip mounted on the identity medium. In such an example, the consumer may be authenticated to a government-endorsed identity without further comparison with information outside of those provided by the consumer at the time of initiating purchase and those stored in the identity medium. In some embodiments, authenticating the consumer may require additional information such as those extracted from databases 404-410. For example, identity information captured at 304 of FIG. 3 may be compared to similar identity information extracted from database 404, which may represent authoritative national identity information maintained by a government agency. In such an example, the accuracy of authentication may be ensure through direct comparison with authoritative information without reliance on secondary identities such as those provided by third party entities (e.g., a bank).

Subsidy entitlement status of the consumer may further be ascertained based on captured information from 304 and information extracted from databases 404-410. In one suitable approach, one or more policy schema server process 414 may, for example, apply government policy schemes to qualify and analyze the captured information and information extracted from databases 404-410. As an example, a government policy may dictate that only national citizens above the age of 17 are eligible for a fuel subsidy. This policy may be supplied to the policy schema server process 414, for example, in the form of designated parameters, which the policy scheme server process 414 may use to selectively screen consumer age information extracted from, for example, database 404. As another example, a government policy may assign different subsidy entitlement levels to different classes of drivers and/or different vehicle engine capacities. Additional designated parameters may be generated to reflect this policy and used by the policy scheme server process 414 to screen captured and extracted information, for example, from a DMV database. In yet another example, a government policy may allocate different subsidy levels to different consumer income levels. Suitable designated parameters may be generated to screen captured and extracted information, for example, from an IRS database. It will be understood by those skilled in the art that a plethora of policies may be similarly reflected as designated parameters, which may then be used by the policy scheme server process 414 to screen captured and extracted information.

In some embodiments, the designated parameters may be generated by the policy schema server process 414, for example, based information submitted to it through a direct interface made available to a subsidy agency. This may enable the relevant subsidy agency to quickly and effectively promulgate new policies or updated existing policies directly and efficiently. Other suitable channels for assigning designated parameters based on policies may also be implemented without departing from the spirit and scope of the present invention.

In view of the complexity introduced by having multiple policy parameters simultaneously at play in screening the various sources of extracted data, it may be desirable to implement an analytical system that coordinates and harmonizes the screening results. In one suitable approach, a scoring system may be implemented, for example, as a part of the policy schema server process 414 to dynamically assign, for example, scaled scores to various types of screen results. The scoring system may provide a harmonized interpretation with regard to the significance of each type of screening results.

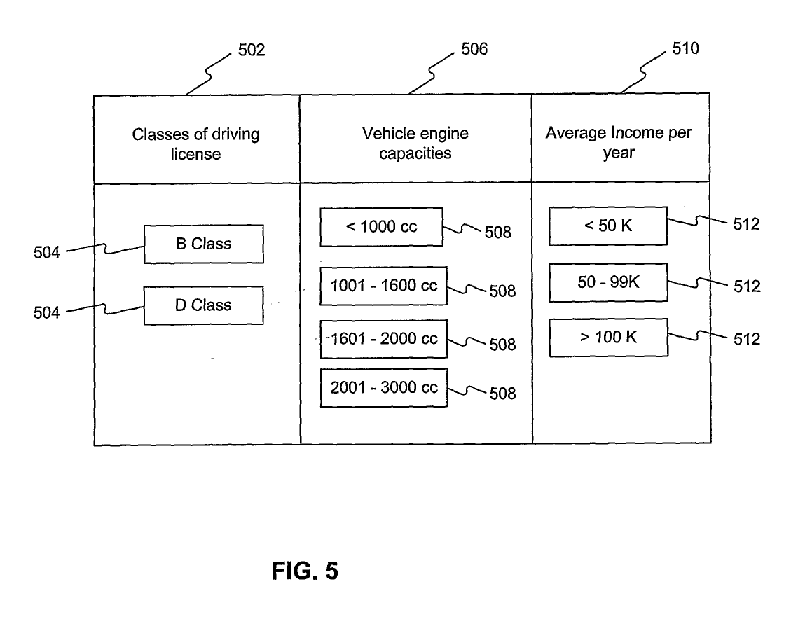

FIG. 5 shows some qualifying criteria that may be used to assign different scores to screening results. As an example, different scores may be generated and assigned to different classes of driving licenses in column 502. The variations in scores assigned to classes 504 may reflect different preference levels for subsidy entitlement. As another example, different scores may be generated and assigned to different vehicle engine capacities in column 506. The different scores for each engine capacity level 508 may correspond to a different preference level for subsidy entitlement. As yet another example, different scores may be generated and assigned to different average incomes in column 510. The different scores for each income group 512 may again reflect a different preference level for subsidy entitlement. In some embodiments, the scores may be determined in real-time to reflect a preference or weight level for the type of information that they correspond to. In some embodiments, the scores across the different scoring categories may be based on the same scale, for example, scored out of one hundred. This common scale may allow the scores to be compared relative to each other across categories. In some embodiments, a sum of the various scores may be calculated to generate a total score, which may be used for further determination of subsidy entitlement status and/or a specific subsidy amount. This further determination will be discussed in more detail below. It will be understood by those skilled in the art that while a specific scoring system and specific types of scores are described above as examples, any other suitable implementation may be substituted without departing from the spirit and scope of the present invention.

In some embodiments, a further score weighing system based on and in addition to the above-described scoring system may be desirable. For example, the subsidy agency may place more emphasis on certain types of extracted information in subsidy evaluation than others. To reflect such emphasis, a preference schema process 416 may be implemented in which different types of extracted and/or screened information, for example, as processed and scored by policy scheme service process 414 above may be separately weighed prior to being combined to produce a total score. In one suitable approach, different weight coefficients may be assigned to corresponding types of screening scores. The weight coefficients may reflect, for example, the relative importance of scored information to each other.

In one example, the subsidy agency may dictate that the average income per year of a consumer is twice as significant in subsidy evaluation as the consumer's class of driving license. In such an instance, a coefficient weighing twice as much may be assigned to the score generated for the screening of the consumer's average income per year as compared to the weight coefficient assigned to the score generated from the screening of the consumer's driving license class.

In an alternatively arrangement, the coefficients may be assigned in such a manner as to represent percentages of the total score. Initial screening scores having more significance would be given more percentage weight in the final score sum in this arrangement. The weight coefficients may then be applied, for example, through multiplication to the corresponding scores associated with different types of extracted and/or screened information to generate weighted scores. The weighted scores may further be combined to produce a final subsidy entitlement score. It will be understood by those skilled in the art that the above weighted scoring scheme is merely exemplary of such a system. Any other suitable arrangement may be used without departing from the spirit and scope of the present invention.

In some embodiments, the final subsidy entitlement score may further be influenced by one or more exceptions. In some embodiments, the exceptions may reduce the final subsidy entitlement score either directly or indirectly through influence on the scoring and/or weighing of the contributing scores. As an example, a consumer's traffic violations may negatively influence the final subsidy entitlement score, the consumer's driving class score, or the weighing of the driving class score. As another example, the consumer's bad vehicle emission record may reduce the final subsidy entitlement score, the consumer's vehicle class score, or the weighing of the vehicle class score. These exceptions that either directly or indirectly influence the final subsidy entitlement score may be applied, for example, through an exceptions scheme process similar to that described above in connection with policy schema server process 412, preference schema 416, or any other suitable process.

Once a final subsidy entitlement score is generated, it may be applied to the evaluation of subsidy entitlement status and/or the determination of a specific subsidy amount or level. As one example, a subsidy guide or subsidy map may be automatically searched and/or otherwise utilized to analyze the final subsidy entitlement score at 418. As an example, the final subsidy score may be compared to a minimum level for subsidy qualification. The automatic search and analysis may additionally map the final subsidy entitlement score, for example, to a subsidy amount, range, or level in a suitable subsidy guide, map, or database. In some embodiments, the mapping of the final subsidy entitlement score to a subsidy amount, range, or level may also include further calculation. The mapping and calculation process may be, for example, dynamically changed based on government directives. In some embodiments, the mapped subsidy amount, range, or level may be applicable, for example, as a maximum of subsidized purchases by the consumer over a certain period of time. The subsidy mapping may be measured in value, quantity, or any other suitable unit. In some embodiments, the subsidy mapping may be specifically for the present purchase and may specify the quantity of subsidized goods, the value of subsidized goods, the subsidy amount, or any other suitable amount for the particular purchase. It will be understood that the above examples are merely illustrative arrangements for determining subsidy entitlement status in accordance with one embodiment of the present invention. Any other suitable approach may be utilized without departing from the spirit and scope of the present invention.

Returning to FIG. 3, once the consumer's subsidy entitlement status has been determined as described above, it may be desirable to calculate any specific subsidy application to the present transaction at 310. This calculation may take place automatically. In one embodiment, the difference between the current market price and a pre-set subsidized price may be calculated and applied to the quantity of the sale to determine a subsidy amount. This calculated subsidy amount may be deducted, for example, from a total applicable subsidy amount that the consumer may be entitled to during a specific period, for example, as determined in combination with the consumer's subsidy entitlement status at 308. In some embodiments, the updated subsidy entitlement amount remaining after application towards the current purchase may be stored in association with the consumer, for example, in a consumer profile such as one created during a registration process, which will be discussed in more detail in connection with FIG. 8 below. In some embodiments, the updated subsidy entitlement amount may be otherwise maintained and applied to the subsidy entitlement status processing of FIG. 4, thereby affecting future dynamic calculations of subsidy entitlement status and amount, for example, during future fuel purchases. As an example, the subsidy amount applicable to the present transaction may change the calculation and/or subsidy mapping assignment discussed above in connection with 418 of FIG. 4. In this way, each time the consumer makes a purchase of subsidized goods such as fuel, the consumer's subsidy entitlement status and entitlement amount may be both dynamically calculated, for example, in view of earlier descriptions in connection with FIG. 4 and in view of any previous subsidy amount already applied, for example, within a certain subsidy period. It will be understood that the above described subsidy application is merely illustrative in accordance with one embodiment of the present invention. Any other suitable approach may be used without departing from the spirit and scope of the present invention.

Upon determination of the customized subsidy application to the purchase as described above, payment settlement for the present transaction may be carried out dynamically at 312. In one suitable approach, the dynamic payment settlement of 312 may include a payment from the consumer at 314, for example, in the form of an electronic payment transaction from the consumer's bank account, credit card account, prepaid account, or any other qualified payment account. Alternatively, the dynamic payment settlement of 312 may include a real-time cash payment from the consumer. If an electronic payment transaction is utilized, the payment transaction 314 from a qualified consumer account may be executed dynamically through an automatic authentication of the consumer to the relevant payment account using the previously verified government-endorsed identity, for example, as described above at 308. This automatic authentication improves efficiency and ensures a secure transaction without requiring the consumer to take any additional action such as separately initiating a payment transaction using a designated bank card, credit card, or any other payment medium. In some embodiments, the dynamic authentication may be enabled by a prior identity authentication process, for example, performed at the time of a consumer registration process. This type of prior authentication will be discussed in more details in connection with FIG. 8 below.

In some embodiments, the payment transaction from the consumer, either in the form of real-time cash payment or as electronic transaction from the consumer's account at 314, may cover the entire amount of the current purchase, for example, at market price, regardless of whether the consumer is entitled to any subsidy for any portion of the purchase amount, for example, as calculated at 310 above. In this arrangement, a separate subsidy rebate process may be automatically initiated to recover any qualified subsidy amount for the consumer at 316. In one example, a subsidy rebate request may be dynamically generated for the qualified subsidy amount such as the amount calculated at 310. The request may be submitted automatically to the subsidy agency, such as an appropriate government agency for rebate payment. The requested amount may be compared against, for example, a record of the entitlement amount such as the amount calculated at 310. If the amount is accurate, the subsidy agency may automatically release the requested rebate payment amount to the consumer, for example, by sending a check to the consumer or by directly making the payment into the consumer's qualified payment account, such as a bank account, credit card account, and/or any other suitable qualified account from which the consumer had made the payment in full at 314. Alternatively, the consumer may designated another method such as another suitable qualified account for receiving rebate payments. In some embodiments, the entire dynamic payment settlement 312 may take place in real-time at the time of the purchase. In some embodiments, the dynamic payment settlement 312 may be performed periodically for one or more accumulated purchases. In some embodiments, a subsidy rebate request need not be generated or transmitted to the subsidy agency. In these embodiments, the subsidy agency may directly access the entitled subsidy amount, for example, as calculated at 310 and make the appropriate rebate payment.

In some embodiments, the consumer payment 314 may only cover a partial portion of the purchase amount, for example, the amount remaining after an appropriate subsidy amount such as the amount calculated at 310 has been applied towards the purchase. In these embodiments, the subsidy rebate 316 from the subsidy agency may be automatically applied towards the purchase amount, for example, in response to a rebate request for the applicable subsidy amount or automatically applied in view of the applicable subsidy calculation without requiring submission of a rebate request. It will be understood that the above descnbed dynamic payment settlement 312 is merely illustrative of the settlement process. Any other suitable approach may be used without departing from the spirit and scope of the present invention.

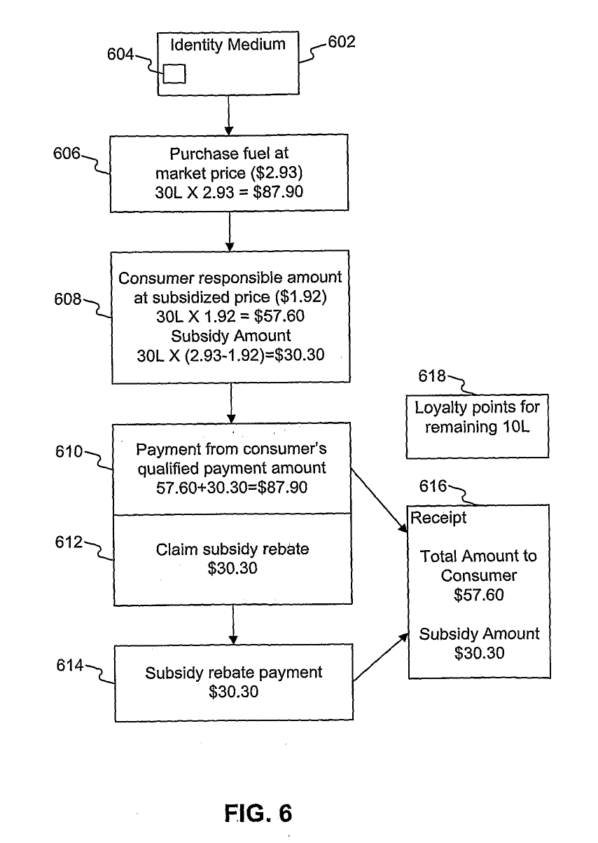

FIG. 6 shows one specific subsidized purchase transaction example in accordance with the general system process described above in connection with

FIGS. 3-5. At 602, a consumer may use a national identity card to initiate a fuel purchase at a fuel pump located at a fuel retailer. The national identity card as illustrated may include an embedded smart chip 604, which may store identity-related information such as consumer name, address, biometric characters such as fingerprint, facial structure, eye scan, etc., and/or any other suitable information related to the consumer. The national identity card may be inserted into, slide through, or otherwise submitted for reading by a card reader, for example, at the fuel pump and/or otherwise made available at the fuel station.

In this example, the market price is shown at $2.93 and a volume of 30 liter was purchased by the consumer, which resulted in a total purchase amount of $87.90 at 606. Also in this example, a relevant subsidy agency had designated a pre-determined subsidized fuel price at $1.92 per liter. To qualify for the subsidized fuel, the consumer may be required to have subsidy entitlement status, which may be determined, for example, as described above in connection with FIG. 3. The information extracted from the consumer's national identity card 602 may include information extracted from smart chip 604. The extracted information may be used in determining whether the consumer possesses subsidy entitlement status and whether the consumer is entitled to a subsidy amount that would be applicable to the current purchase.

As an example, the consumer's age, driving license class, vehicle engine capacity, average income per year, and other suitable information may be extracted from the national identity card 602 and/or otherwise extract, for example, from relevant secure data sources such as those described in connection with FIG. 4, to determine whether the consumer has subsidy entitlement status according to a process such as described in connection with 308 of FIG. 3. If the consumer indeed has subsidy entitlement status, suitable subsidy calculations such as those described in connection with 310 of FIG. 3 may determine the subsidy amount that the consumer is entitled to, for example, within a certain period (e.g., in a week) and/or for this specific purchase transaction. The subsidy amount may be provided in the form of monetary value, purchase quantity, or any other suitable form. If the entitled subsidy amount is for a certain period, the subsidy amount may be dynamically updated as purchases are made during the subsidy period to reflect the most current availability of subsidy towards the current purchase.

In this particular example, it has been determined that the consumer is currently entitled to an available subsidy purchase volume of 40 liters. Since the consumer's current purchase is for 30 liters, it is within the subsidized volume. Therefore, the consumer is entitled to the purchase of 30 liters of subsidized fuel at the pre-determined subsidized price of $1.92, which totals $57.60 at 608. The difference between the market price of $2.93 and the pre-determined subsidized price of $1.92 is used to generate an applicable subsidy amount of $30.30 for the current purchase. In this example, the amount that the consumer is responsible for after application of the entitled subsidy initiates an automatic payment transaction from the consumer, for example, as a cash transaction or as a transaction from the consumer's qualified payment account, which may be, for example, a prepaid account, debit account, credit card account, or any other qualified payment account at 610. The qualified payment account may have been determined, for example, during a consumer registration process, which will be discussed in connection with FIG. 8. The qualified payment account may also be dynamically identified, selected, and/or authenticated based on information captured in connection with the consumer including information from the national identity card 602 and/or extracted from other data sources as outlined in connection with FIG. 3.

Regardless of whether a cash transaction is used or how the qualified payment account is determined, an automatic payment transaction may either require the consumer to provide the amount that the consumer is responsible for ($57.60) in cash form or automatically deduct the amount from the consumer's qualified payment account at 610. In some embodiments, the subsidized amount of $30.30 may also be requested from the consumer in cash form or deducted from the qualified payment account at 610, thereby providing a complete payment for the fuel purchase to the retailer regardless of the subsidy. In such situation, the applicable subsidy amount may be claimed back from the subsidy agency in this example at 612. For example, the subsidy agency may make a subsidy rebate payment of $30.30 at 614, for example, in check form or as credit to the consumer's qualified payment account or any other suitable account. The rebate payment may take place in real-time or immediately subsequent to the transaction and therefore creating no significant financial burden on the part of the consumer. The cash payment by the consumer or deduction of the full amount from the consumer's account may be merely for the purpose of ease in accounting. Alternatively, the rebate payment of 614 may take place periodically, for example, to allow multiple payment rebates to be consolidated.

At the completion of the current fuel purchase, the consumer may receive a receipt such as the one shown at 616. The receipt may state the total amount charged to the consumer in cash form or as deduction from the consumer's qualified payment account as well as the subsidy rebate amount. In some embodiments, if the consumer does not use up the entire subsidy entitlement amount within a certain period that has been allocated to the consumer, for example, a volume of 40 liters in this example, the remaining unused entitlement amount may be converted into loyalty points such as reward points that the consumer may later apply to purchases of other goods, future fuel purchases, and/or any other suitable reward options at 618. The loyalty points may be additionally associated with, for example, specific retailers, specific goods, specific services, etc.

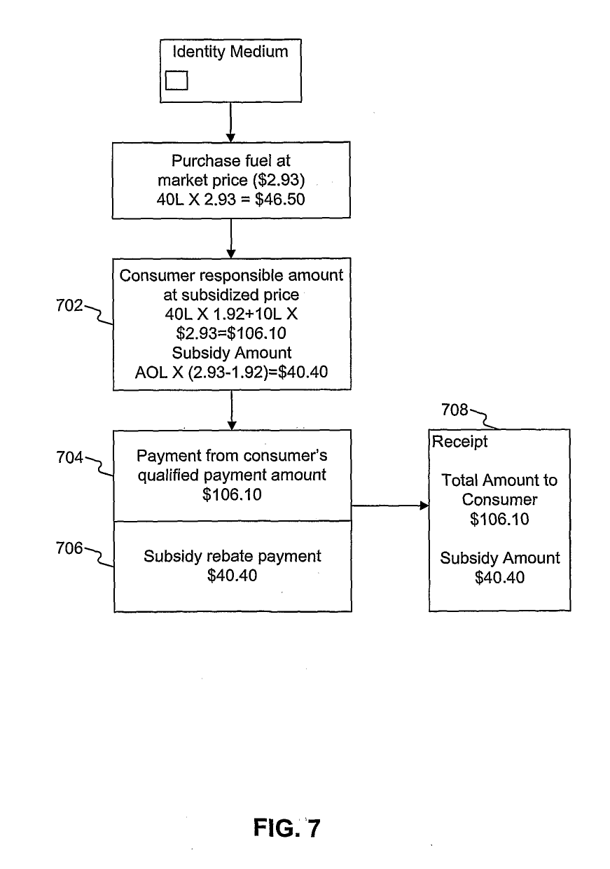

FIG. 7 shows another specific'purchase transaction example based on the system processes described above in connection with FIGS. 3-5. This example is similar to the example of FIG. 6 in that the consumer has been determined as having entitlement at the present time to a subsidized volume of 40 liters of fuel during a certain period. What is different in this example is that the consumer is attempting to purchase 50 liters of fuel during the present transaction. In this case, the consumer is calculated as being responsible for the entitled 40 liters at the subsidized price of $1.92, while the remaining 10 liters must be purchased at the market price of $2.93 at 702. The subsidy amount is calculated as being the difference between the fuel sale at market price and the fuel sale at the subsidized price for only the entitlement amount of 40 liters for a total of $40.40. In this example, only the amount that the consumer is responsible for ($106.10) may be required from the consumer in cash form or as deduction from the consumer's qualified payment account at 704 as described above in connection with FIG. 6. The subsidized amount of $40.40 may be directly settled, for example, with the retailer, by the subsidy agency in the form of subsidy rebate at 706. A receipt to the consumer at 708 may reflect the total amount responsible to the consumer and the subsidy amount applicable. It will be understood that FIGS. 6 and 7 show specific examples in accordance with an embodiment of the invention. Many variations may be introduced without departing from the spirit and scope of the present invention.

In some embodiments, a consumer may complete an initial automated registration process prior to purchase of subsidized goods, for example, using a government-endorsed identity medium. The registration process may include at least a portion of the process described above in connection with the purchase of subsidized goods in FIG. 3. For example, the registration process may perform an initial authentication of the consumer to a verified government-endorsed identity, perform an initial selection and verification of one or more qualified payment account such as a credit card account, a debit card account, a bank account, or any other suitable payment account, perform an initial data extraction relevant to the consumer, for example, for subsidy calculations, perform an initial subsidy entitlement assessment, and/or perform any other suitable preliminary activities, which may simplify the performance of activities of corresponding types during a purchase transaction of subsidized goods.

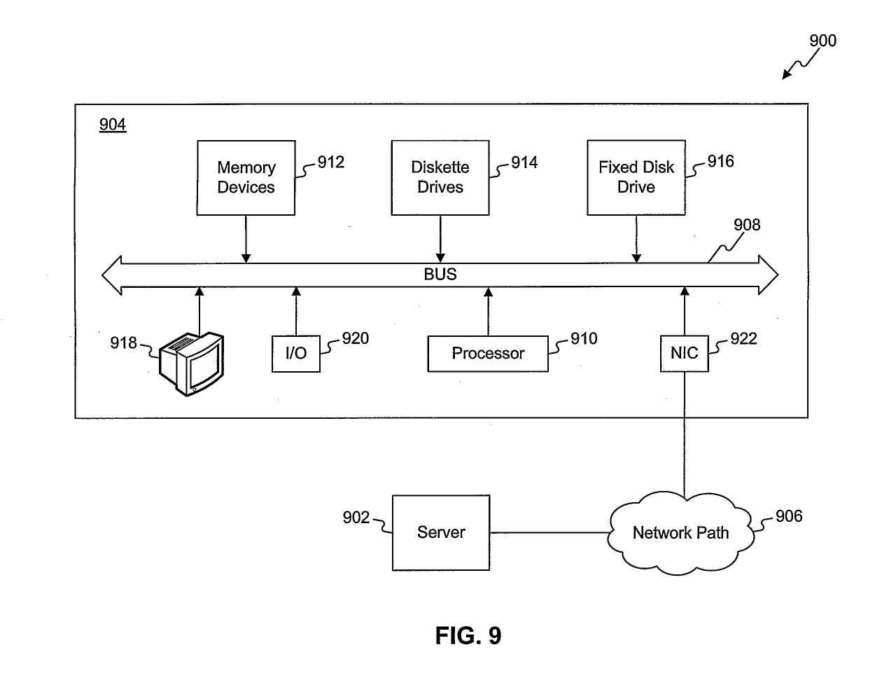

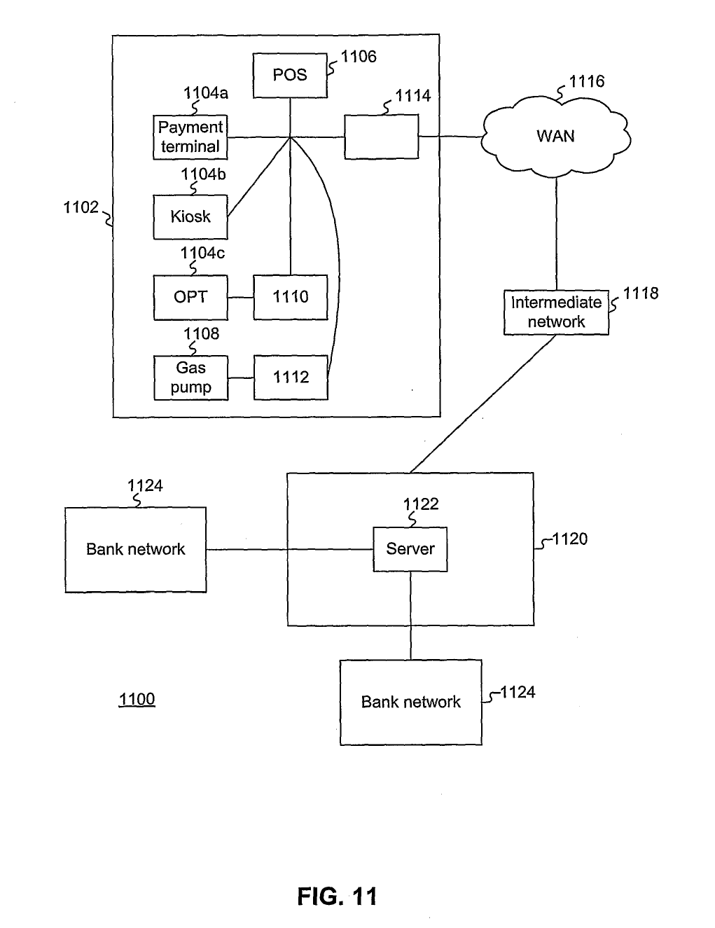

FIG. 8 shows an illustrative registration process that may be implemented in accordance with one embodiment. The automated registration process may be initiated, for example, when information is read from a government-endorsed identity medium such as a national identification card associated with a consumer at 800. The information may be read via any suitable card reader, which will be described in connection with suitable system components in connection with FIG. 11. The information may be read in the form of stored information in the magnetic strip of the identity medium, in a smart chip mounted on the identity medium, or in any other suitable form. The obtained information may be used to first determine if a registration record already exist in connection with the consumer at 802. For example, relevant information read at 800 such as consumer name and/or other suitable information may be communicated to a processing system, which has access to consumer registration records. A suitable processing system will be discussed in connection with suitable system components in connection with FIGS. 9-11. If the processing system determines, based on the relevant information from 800, for example, through a search in one or more relevant registration record databases, that a registration record already exists, then the registration process may be terminated.

Alternatively, if no matching record is found, the consumer and/or the government-endorsed identification medium associated with the consumer may be authenticated at 804. In some embodiments, biometric information such as consumer's fingerprint, eye scan, facial structure measurement, and/or any other suitable data may also be captured at 800. Suitable equipment such as a fingerprint scanner may be provided for capturing of such data. The captured biometric data may be converted into digital data. This digital data may, in some instances, be compared to comparable digital data, for example, saved in the smart chip mounted on the identification medium. The consumer may be authenticated against this saved data. Alternatively, the captured information may be transmitted to the processing system mentioned above for authentication. In such an arrangement, the authentication process may follow a similar process to that earlier described in connection with the authentication process at 308 of FIG. 3. More specifically, the processing system may utilize a data mining system such as described in connection with FIG. 4 to extract appropriate data associated with the consumer from various secure and verified data sources such as government databases to authenticate the user against the information captured at 800.

If the authentication fails at 804, for example, when certain data such as captured biometric data does not match the saved data of comparable type, the registration may be terminated. Alternatively, if the authentication is successful, a registration record may be created for the consumer at 806. The registration record may automatically extract and save, for example, information read from the identification medium at 800 and biometric information captured at 804. The registration record may also include an initial extraction of, for example, relevant data that may be useful for subsidy evaluation from a plurality of verified data sources such as according to the data mining process described in connection with FIG. 4. In some embodiments, the registration record may additionally include an initial subsidy entitlement evaluation result, for example, as described in connection with FIG. 4. The inclusion of the initial extract of information and the initial subsidy entitlement result according to the process of FIG. 4 in the registration record may simplify and streamline the subsidy entitlement evaluation performed at the time of a purchase transaction as described, for example, in connection with FIG. 3.

The consumer may additionally be authenticated to one or more qualified payment accounts, for example, for facilitating automatic payment of purchase transactions in the future. Because the consumer has already been authenticated as having a valid government-endorsed identity, for example, a national identity, the consumer may be automatically authenticated to one or more qualified payment accounts. In one example, the consumer may be provided with a list of available payment accounts from which the consumer may select, for example, one or more accounts for making future purchase payments at 808. The list of available payment accounts may include bank accounts, debits accounts, credit card account, and/or any other suitable account to which the consumer may be properly authenticated based on authentication performed, for example, at 804. This list of accounts may be generated dynamically without input from the consumer. In some embodiments, any or all of the listed accounts may be made available in addition to the option of cash transaction for purchase payments and/or for receiving rebate payments and the consumer may select the payment account at the time of purchase. In some embodiments, the consumer may select a default account for these future transactions at 804. The suitable qualified account information may be stored in the registration record of the consumer to facilitate and streamline future payment and rebate transactions to and from these accounts, for example, as described in connection with FIG. 3.

In some embodiments, the financial institutions responsible or affiliated with the qualified payment accounts of 804 may be notified of the consumer's registration and/or be provided with the consumer's authentication information to allow ease of transactions at a later time. As previously mentioned, because the consumer has been properly authenticated to a government-endorsed identity, there may be no need to separately authenticate the consumer to any of the financial institutions based on, for example, any secondary identities such as bank user ids or passwords.

It will be understood that the above registration process is merely illustrative of an initial registration process that a consumer may perform to facilitate and streamline future purchases of goods, such as subsidized goods, based on the consumer's authenticated government-endorsed identity. Those skilled in the art will understand that the registration process may be embodied and subsumed by an expanded process at the time of purchase, for example, as described in connection with FIGS. 3 and 4. The utilization of a registration record may simplify the process during a purchase transaction, for example, by providing a record of relevant information without requiring additionally data mining, by providing qualified payment account information without requiring dynamic discovery of payment options at the time of purchase, and by providing other types of relevant information that facilitates purchase transactions. Whether or not a registration process is implemented or to what extent a registration record is kept does not affect the spirit and scope of the present invention.

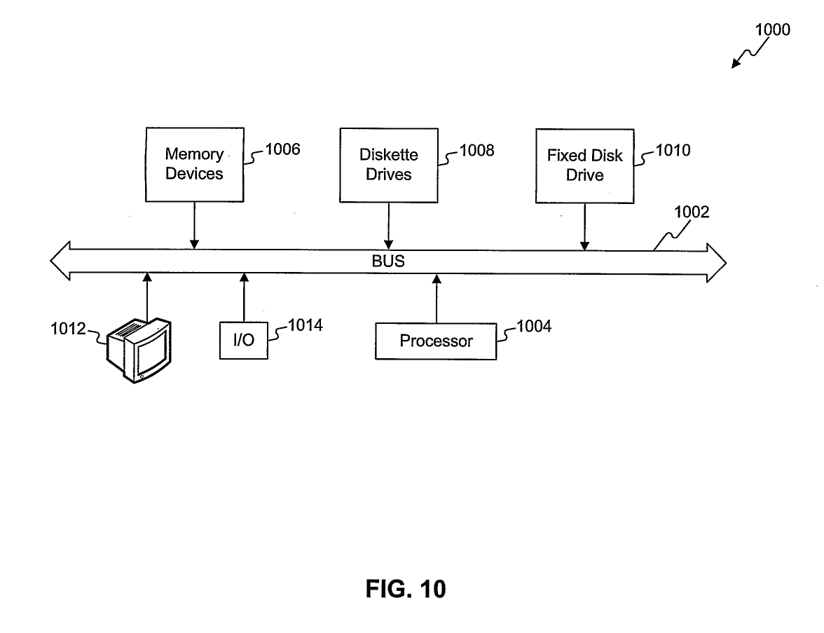

A computer system may be used to install a software application implementing a system and method for supporting functionalities associated with an embodiment of the present invention. At a very high level, the computer system may be a computer network, as shown in FIG. 9, or a stand-alone personal computer (PC), as shown in FIG. 10.

As shown in FIG. 9, a computer network 900 in accordance with systems consistent with the principles of the present invention may include one or more server 902 and one or more stand-alone PC 904 connected through a network path 906. Computer network 900 may be a local area network (LAN), where server 902 and PC 904 are workstations. Computer network 900 may also be the Internet, with server 902 hosting, for example, a web application and PC 904 being any workstation available to a consumer desiring to interface with the application on server 902. Alternatively, computer network 900 may be a wide area network (WAN), and server 902 and PC 904 may lie in two separate LANs connected through the Internet.

PC 904 may include a bus line 908 connecting a plurality of devices such as a processor 910, memory devices 912 for storage of information, diskette drives 914, a fixed disk drive 916, a monitor or display 918, other I/O devices 920, and a network interface card (NIC) 922. Processor 910 may be a microprocessor such as an Intel Pentium™ chip for processing applications. Memory devices 912 may include read-only memories (ROM) and/or random access memories (RAM). Diskette drives 914 may include a floppy drive, a compact disk (CD) drive, a removable media drive capable of reading, for example, SD, mini SD, or microSD cards, CF cards, XD cards, and/or any other suitable media cards, a USB storage device or any other suitable drives and/or devices. Fixed disk drive 916 may be a hard drive. I/O devices 920 may include a keyboard and/or a mouse for receiving input from a user of PC 904. Monitor or display 918 may display output from processor 910, and may also echo the input of the user. PC 904 may be connected to network path 906 through NIC 922. It will be understood that

NIC 922 is used herein as a general term to reference a variety of suitable network interfaces cards and devices such as wireless network interfaces cards (e.g., WIFI, WiMax, etc.), wireless connection devices (e.g., Bluetooth, IR, etc.), mobile/radio data network interface cards (e.g., GPRS, EDGE, HSPDA, 3G, etc.), and/or any other suitable network interface type cards and/or devices.

A web application for performing at least some functionalities of an embodiment of the present invention may be installed on server 902. An individual desiring to enter data into the application on server 902 may use a web browser loaded on PC 904, and may communicate with server 902 through NIC 922 and network path 906. In one aspect, software application for implementing a system consistent with the principles of the present invention may be stored in PC 904 and processor 910 of PC 904 may execute the software application locally within PC 904 and interface with a web application on server 902. Particularly, the software application may be stored on a floppy disk, a CD, or any other suitable readable media, which may be accessible by diskette drive 914, fixed disk drive 916, or any other suitable mechanism. In another aspect, the software application for implementing a system consistent with the principles of the present invention may be stored in server 902, which may execute the software application, and processor 910 of PC 904 may communicate with server 902 to send information to server 902 and retrieve the results of the execution of the software application from server 902.

Through the execution of the software application implementing a system consistent with the principles of the present invention, either locally within PC 904 or remotely within server 902, an interface or screen may be provided on a user display.

Alternatively, as shown in FIG. 10, a stand-alone PC 1000 may be used for implementing a software application implementing a system consistent with an embodiment of the present invention. PC 1000 may include a bus line 1002 connecting a plurality of devices, which may include a processor 1004, memory devices 1006 for storage of information, diskette drives 1008, a fixed disk drive 1010, a monitor or display 1012, and other I/O devices 1014. Processor 1004 may be a microprocessor such as an Intel Pentium™ chip for processing applications. Memory devices 1006 may include

ROM and/or RAM. Diskette drives 1008 may include a floppy drive and/or a compact disk (CD) drive. Fixed disk drive 1010 may be a hard drive. Monitor or display 1012 may display the output of processor 1004 and may also echo the input of the user. I/O devices 1014 may include a keyboard and/or a mouse for receiving input from a user of PC 1000.

A software application implementing a system consistent with the principles of the present invention may be stored on a floppy disk, a CD, or any other medium accessible by diskette drive 1008 or on fixed disk drive 1010. Processor 1004 may execute the software application stored in the floppy disk, the CD, or the fixed disk drive 1010. An individual, through monitor or display 1012 and I/O devices 1014, may interact with processor 1004, which may execute the software application. A software application implementing a system consistent with the principles of the present invention may be written in any number of programming languages, including but not limited to JavaScript, Visual Basic, Flash, ABAP coding, or any other suitable language. Similarly, the present invention is not limited to use with certain applications, Internet browsers or operating systems.

Furthermore, the invention may be practiced in an electrical circuit comprising discrete electronic elements, packaged or integrated electronic chips containing logic gates, a circuit utilizing a microprocessor, or on a single chip containing electronic elements or microprocessors. The invention may also be practiced using other technologies capable of performing logical operations such as, for example, AND, OR, and NOT, including but not limited to mechanical, optical, fluidic, and quantum technologies. In addition, the invention may be practiced within a general purpose computer or in any other circuits or systems.

While the present invention has been described in connection with various embodiments, many modifications will be readily apparent to those skilled in the art. One skilled in the art will also appreciate that all or part of the systems and methods consistent with the present invention may be stored on or read from computer-readable media, such as secondary storage devices, like hard disks, floppy disks, and CD-ROM; a carrier wave received from a network such as the Internet; or other forms of ROM or RAM. Accordingly, embodiments of the invention are not limited to the above described embodiments and examples, but instead is defined by the appended claims in light of their full scope of equivalents.

FIG. 11 shows an illustrative network system 1100 for purchase of subsidized fuel that is consistent in implementation with the above high level computer systems and in accordance with a particular embodiment of the present invention. A consumer may come into contact with network system 1100 through, for example, endpoint devices 1104, which may be installed, for example, at a petrol station 1102. One suitable endpoint device 1104 may be a payment terminal 1104a or a kiosk 1104b. The payment terminal 1104a may include, for example, a system controller such as a PC, a card reader for extracting information from an identity medium such as a national identity card, biometric information scanner such as a fingerprint scanner, and/or any other suitable components. The card reader may be communicatively coupled to the PC. The consumer may initiate one or more activities such a payment activity or any other suitable activity at a payment terminal 1104a. For example, the consumer may insert or slide a government-endorsed identity medium into or through the card reader coupled to endpoint device 1104.

In some embodiments, endpoint device 1104 may perform registration and payment activities. In some embodiments, endpoint device 1104 may only perform some portions of available consumer activities (e.g., registration and payment). As an example, kiosk 1104b may include similar components to those discussed above in connection with payment terminal 1104a including a PC, a card reader, a biometric scanner, and/or any other suitable components. Kiosk 1104b may additionally include components such as user input components that enable the consumer to input information such as, for example, making a selection of payment account as described above in connection with the registration process of FIG. 8. In some embodiments, payment terminal 1104a and kiosk 1104b may be provided as an integrated system, may be coupled to or integrated with point of sale (POS) terminals 1106, or may be implemented in a variety of other fashion. In some embodiments, the endpoint device 1104 may also take the form of an outdoor payment terminal (OPT) 1104c. The OPT 1104c may be, for example, incorporated into or coupled to a fuel pump 1108. In some embodiments, OPT terminal 1104c and its corresponding fuel pump 1108 may communicate with respective controllers 1110 and 1112. The OPT terminal 1104c may include some or all of the components described above in connection with payment terminal 1104a and kiosk 1104b.

Regardless of which, where, or how one or more endpoint device 1104 is implemented, the endpoint device 1104 may communicate with one or more external network to facilitate dynamic transactions such as payment transactions. In one example, a WAN device 1114 may facilitate communication between the various devices 1104-1112 with an external WAN network 1116 (e.g., the Internet). Alternatively, communications to and from the devices 1104-1112 may be transmitted over, for example, a communication channel in a LAN, dedicated lines, wireless network, or any other suitable communication channel. In some embodiments, WAN network 1116 or any other suitable communication channel may relay data transmitted from devices 1104-1112 to an intermediate network 1118 such as an internal network associated with the fuel retailer. Network 1118 may, in some instances, simply route the received data to a transaction processing system 1120. Network 1118 may also, in some embodiments, process the received data, for example, to maintain purchase records, to log loyalty or other reward points, to supplement the data with other data such as previous purchases, or to perform any other suitable data processing. Network 1118 may then transmit the processed data to transaction processing system 1120. In some embodiments, network 1118 may be entirely bypassed. Network 1118 may additionally be integrated with transaction processing system 1120 in some embodiments.

Transaction processing system 1120 may include central processing server 1122. Central processing server 1122 may performing, for example, data mining and/or subsidy scheme processing functionalities such as those described in connection with FIGS. 3 and 4. Central processing server 1122 may also interface with external systems, databases, and/or applications including, for example, external secure databases such as databases 404-410 of FIG. 4, government scheme setting applications, and/or any other suitable data sources, systems and applications. Central processing server 1122 may additionally communicate with external banking systems 1124, for example, to facilitate payment transactions, rebate settlements, and/or any other suitable banking-related transactions such as those described above in connection with FIGS. 3-8.

In one specific application of the network system of FIG. 11, a consumer may insert an identity medium into a card reader associated with endpoint device 1104 at a petrol station 1102. The end point device 1104 may be a device mounted on a gas pump 1108. Data may be extracted from the identity medium by the card reader including, for example, from a smart chip mounted on the identity medium. At the same time, the endpoint device 1104 may also require the consumer to submit a fingerprint sample through a fingerprint scanner coupled to the end point device 1104. The combination of captured data may be transmitted, for example, through WAN 1116 or any other suitable communication channel and any other suitable intermediate system or network such as intermediate network 1118 to transaction processing system 1120. The central processing server 1122 may use the captured information to authenticate the consumer to a government-endorsed national identity, for example, by comparing the captured information to trusted information extracted from trusted data sources as described above in connection with FIGS. 3 and 4. If a government-endorsed identity is properly authenticated, central processing server 1122 may further determine the consumer's subsidy entitlement status, amount, and or any other suitable subsidy-specific information, for example, as described in connection with FIGS. 3 and 4. In one example, the central processing server 1122 may extract data associated with the consumer for subsidy entitlement determination, including the consumer's income level, vehicle specification, etc. from trusted data sources such as government databases and analyze such information to determine subsidy entitlement in view of suitable government schemes. The government schemes may be submitted by a suitable subsidy agency, for example, through an interface to central processing server 1122, extracted from a trusted data source for such schemes, and/or obtained using any other suitable arrangement. The central processing server 1122 may further determine the specific subsidy amount applicable to the present purchase transaction, for example, using an arrangement such as described above in connection with FIG. 4.

Regardless of whether the consumer is entitled to subsidy, central processing server 1122 may automatically identify payment options and facilitate a payment transaction, for example, from a qualified payment account. In one example, the consumer may have a plurality of qualified payment accounts including credit accounts, debit accounts, bank accounts, and/or any other suitable accounts. The central processing server 1122 may automatically identify these accounts based on the consumer's authenticated government-endorsed identity. These payment account options may be presented to the consumer for selection at endpoint device 1104, for example, in a menu. Alternatively, a default or dedicated qualified payment account may be automatically selected. In some embodiments, promotional information may also be presented to the consumer, for example, providing options for discounts on the purchase if a particular payment account is chosen.

Once a qualified payment account is determined by the central processing server 1122, server 1122 may communicate with the relevant bank 1124 to facilitate a payment transaction. In some embodiments, the payment transaction may involve deduction of the entire purchase amount from the consumer's qualified payment account, for example, when the consumer is not entitled to subsidy for the present transaction and/or when a separate rebate transaction will be carried out for the subsidy amount. In some embodiments, the payment transaction may only involve a partial amount of the payment transaction, for example, the actual amount that the consumer is responsible for post subsidy application.

Bank 924 may approve the payment transaction automatically, for example, based on the previously authenticated government-endorsed identity by the central processing server 1122, without requiring additional actions from the consumer. In some embodiments, approval from bank 1124 may take place prior to actual sale of the goods, for example, prior to pumping of fuel at petrol station 1102. In these embodiments, bank 1124 may approve, for example, a certain maximum amount that may be charged to the qualified account. Once bank 1124 provides the approval, the central processing server 1122 may communicate with the pump controller 1112, which may then release the pump 1108 for fueling. The payment transaction may be directly carried out, for example, between the relevant consumer qualified payment account and the petrol retailer's receiving account.

The central processing server 1122 may additionally facilitate subsidy rebate payments, for example, from the government. In one example, the entire purchase value may be first deducted from the consumer's qualified payment account. The central processing server 1122 may submit a request for relevant subsidy that the consumer is entitled to for the present transaction, for example, as determined in accordance with a process described in connection with FIG. 4, to the relevant subsidy agency. In some embodiment, the central processing server 1122 may directly access a qualified subsidy payment account associated with subsidy rebate payments, for example, at bank system 1124. The rebate payments may be authenticated based on the previously determined government-endorsed identity by the central processing server 1122 and may require no additional action from the consumer. In response, the subsidy agency may release a corresponding rebate payment, for example, through bank 1124, which may be directly deposited into the consumer's qualified payment account or another designated account. Alternatively, when only a partial payment is deducted from the consumer's qualified payment account, the central processing server may facilitate the relevant rebate payment to an account in connection with, for example, the petrol retailer. In some embodiments, the central petrol server 1122 may consolidate one or more rebate payments, for example, for the same consumer over a period of time, and facilitate one combined rebate payment. In some embodiments, the rebate payment may be made automatically at the time of the purchase transaction. Alternatively, the rebate payment may be made periodically or at any other desirable time.

It will be understood that the above-described network system architecture is merely one example of a system consistent with the principles of the present invention. Suitable elements may be incorporated, removed, or otherwise modified without departing from the spirit and scope of this disclosure.

What is claimed is:

1. A system for dynamically applying a customized subsidy to a purchase of subsidized goods based on a government-endorsed identity associated with a consumer, the system comprising:
an endpoint device configured to capture information from the consumer including capturing information from an identity medium associated with the consumer; and
a server configured to:
enable the consumer to initiate purchase of subsidized goods,
dynamically determine a customized subsidy applicable towards the purchase of the subsidized goods, wherein the dynamically determining comprises automatically determining subsidy entitlement status of the consumer for the purchase based on an authentication of the consumer to a government-endorsed identity using at least a portion of the information captured by the endpoint device and automatically calculating the customized subsidy applicable to the purchase based on one or more characteristics associated with the government-endorsed identity, and
dynamically perform payment settlement for the purchase, wherein performance of the payment settlement comprises automatically initiating a payment transaction from the consumer and automatically obtaining a subsidy rebate for the customized subsidy applied to the purchase.

2. The system of claim 1, wherein automatically initiating a payment transaction from the consumer comprises at least one of automatically initiating a cash payment transaction from the consumer and automatically initiating a payment transaction from a qualified payment account associated with the consumer.

3. The system of claim 1, wherein the identity medium is an identity card having at least one of a magnetic strip and a smart chip and the endpoint device comprises a card reader for capturing at least one of information from the magnetic strip and information from the smart chip.

4. The system of claim 1, wherein the endpoint device comprises an I/O device for capturing input information from the consumer.

5. The system of claim 1, wherein the endpoint device comprises a biometric reader for capturing biometric information from the consumer.

6. The system of claim 1, wherein the server is configured to authenticate the consumer to the government-endorsed identity by comparing at least a portion of the information captured by the endpoint device to information associated with the consumer extracted from one or more secure databases.

7. The system of claim 5, wherein the server comprises an index server having one or more location pointers to relevant information in the one or more secure databases and the server is configured to identify and extract information associated the consumer from at least one location pointed to by a location pointer.

8. The system of claim 5, wherein the one or more secure databases include a government agency database.

9. The system of claim 1, wherein the server is configured to authenticate the consumer to the government-endorsed identity by comparing at least a portion of the information captured by the endpoint device from the identity medium to at least a portion of comparable information captured by the endpoint device from the consumer.

10. The system of claim 1, wherein the server is configured to automatically calculate the customized subsidy applicable to the purchase based on one or more characteristics associated with the government-endorsed identity, wherein the one or more characteristics is at least one of consumer characteristics including at least one of age, driver's license class, and income level and vehicle characteristics including at least one of vehicle engine capacity and vehicle emission level.

11. The system of claim 1, wherein the server is configured to extract one or more characteristics associated with the government-endorsed identity from the one or more secure databases.

12. The system of claim 10, wherein the server is further configured to perform a policy schema server process that calculates the customized subsidy applicable to the purchase by applying the one or more characteristics associated with the government-endorsed identity to one or more subsidy policy parameters.

13. The system of claim 11, wherein the server is further configured to score one or more results from application of the one or more characteristics associated with the government-endorsed identity to the one or more subsidy policy parameters.

14. The system of claim 11, wherein the server is further configured to perform a preference schema process that weighs one or more results from application of the one or more characteristics associated with the government-endorsed identity to the one or more subsidy policy parameters relative to each other.

15. The system of claim 1, wherein the server is further configured to utilize a subsidy guide to generate the customized subsidy applicable to the purchase.

16. The system of claim 2, wherein the server is configured to automatically authenticate the consumer to the qualified payment account during payment settlement based on the government-endorsed identity and initiate the payment transaction from the qualified payment account associated with the consumer for at least a portion of the purchase.

17. The system of claim 1, wherein the server is further configured to submit a request for the subsidy rebate associated with the purchase to a subsidy agency.

18. The system of claim 2, wherein the server is further configured to facilitate payment of the subsidy rebate to the qualified payment account of the consumer.

19. The system of claim 2, wherein the qualified payment account is one of a credit card account, a debit card account, and a bank account.

20. A method for dynamically applying a customized subsidy to a purchase of subsidized goods using a computer system based on a government-endorsed identity associated with a consumer, the method comprising:
capturing information from the consumer using an endpoint device including capturing information from an identity medium associated with the consumer;
enabling the consumer to initiate purchase of subsidized goods;
dynamically determining a customized subsidy applicable towards the purchase of the subsidized goods, wherein the dynamically determining comprises automatically determining subsidy entitlement status of the consumer for the purchase based on an authentication of the consumer to a government-endorsed identity using at least a portion of the information captured by the endpoint device and automatically calculating the customized subsidy applicable to the purchase based on one or more characteristics associated with the government-endorsed identity; and
dynamically performing payment settlement for the purchase, wherein performance of the payment settlement comprises automatically initiating a payment transaction from the consumer and automatically obtaining a subsidy rebate for the customized subsidy applied to the purchase.

21. The method of claim 20, wherein automatically initiating a payment transaction from the consumer comprises at least one of automatically initiating a cash payment transaction from the consumer and automatically initiating a payment transaction from a qualified payment account associated with the consumer.

22. The method of claim 20, wherein the identity medium is an identity card having at least one of a magnetic strip and a smart chip and the endpoint device comprises a card reader for capturing at least one of information from the magnetic strip and information from the smart chip.

23. The method of claim 20, wherein the endpoint device comprises an I/O device for capturing input information from the consumer.

24. The method of claim 20, wherein the endpoint device comprises a biometric reader for capturing biometric information from the consumer.

25. The method of claim 20, further comprising authenticating the consumer to the government-endorsed identity by comparing at least a portion of the information captured by the endpoint device to information associated with the consumer extracted from one or more secure databases.

26. The method of claim 25, further comprising using an index server having one or more location pointers to relevant information in the one or more secure databases to identify and extract information associated the consumer from at least one location pointed to by a location pointer.

27. The method of claim 25, wherein the one or more secure databases include a government agency database.

28. The method of claim 20, further comprising authenticating the consumer to the government-endorsed identity by comparing at least a portion of the information captured by the endpoint device from the identity medium to at least a portion of comparable information captured by the endpoint device from the consumer.

29. The method of claim 20, further comprising automatically calculating the customized subsidy applicable to the purchase based on one or more characteristics associated with the government-endorsed identity, wherein the one or more characteristics is at least one of consumer characteristics including at least one of age, driver's license class, and income level and vehicle characteristics including at least one of vehicle engine capacity and vehicle emission level.

30. The method of claim 20, further comprising extracting one or more characteristics associated with the government-endorsed identity from the one or more secure databases.

31. The method of claim 30, further comprising performing a policy schema server process that calculates the customized subsidy applicable to the purchase by applying the one or more characteristics associated with the government-endorsed identity to one or more subsidy policy parameters.

32. The method of claim 31, further comprising scoring one or more results from application of the one or more characteristics associated with the government-endorsed identity to the one or more subsidy policy parameters.

33. The method of claim 30, further comprising performing a preference schema process that weighs one or more results from application of the one or more characteristics associated with the government-endorsed identity to the one or more subsidy policy parameters relative to each other.

34. The method of claim 20, further comprising utilizing a subsidy guide to generate the customized subsidy applicable to the purchase.

35. The method of claim 21, further comprising automatically authenticating the consumer to the qualified payment account during payment settlement based on the government-endorsed identity and initiate the payment transaction from the qualified payment account associated with the consumer for at least a portion of the purchase.

36. The method of claim 20, further comprising submitting a request for the subsidy rebate associated with the purchase to a subsidy agency.

37. The method of claim 21, further comprising facilitating payment of the subsidy rebate to the qualified payment account of the consumer.

38. The method of claim 21, wherein the qualified payment account is one of a credit card account, a debit card account, and a bank account.
